(19) United States
(12) Patent Application Publication
(10) Pub. No.: US 2005/0060146 A1
(43) Pub. Date: Mar. 17, 2005

(54) Method of and apparatus to restore audio data

(76) Inventor: Yoon-hark Oh, Suwon-si (KR)

Correspondence Address: STANZIONE & KIM, LLP, 1740 N STREET, N.W., FIRST FLOOR, WASHINGTON, DC, 20036, US

(21) Appl. No.: 10/934,500

(22) Filed: Sep. 7, 2004

(30) Foreign Application Priority Data
Sep. 13, 2003 (KR) 2003-63474

(51) Int. Cl. G10L 19/02

(52) U.S. Cl. 704/229

(57) ABSTRACT

A method of and an apparatus to restore high frequency of a moving picture experts group audio layer 3 (MP3) audio signal within a decoder. The method includes: setting modified discrete cosine transform (MDCT) coefficients of low bands and high bands of an audio signal, based on scale factor information of each band; extracting MDCT coefficients of low bands per band based on scale factors of each band after dequantizing inputted compressed audio bitstream; selecting the MDCT coefficients of the set low bands that corresponds to patterns of MDCT coefficients of low bands of the inputted compressed audio bitstream, and selecting the MDCT coefficients of the high bands that matches with the MDCT coefficients of the selected low bands; and performing an inverse MDCT by adding the MDCT coefficients of the selected high bands with the MDCT coefficients of the low bands.

### CROSS-REFERENCE TO RELATED APPLICATIONS

This application claims the priority of Korean Patent Application No. 2003-63474, filed on Sep. 13, 2003, in the Korean Intellectual Property Office, the disclosure of which is incorporated herein in its entirety by reference.

### BACKGROUND OF THE INVENTION

1. Field of the Invention

The present general inventive concept relates to an audio compressing/decoding system, and more particularly, to a method of restoring a high frequency moving picture experts group audio layer 3 (MP3) audio signal within a decoder, and an apparatus thereof.

2. Description of the Related Art

Generally, moving picture experts group (MPEG) audio is a standard used for high quality, high efficiency encoding, and is regulated by the international organization for standardization/international electrotechnical commission (ISO/IEC). MPEG audio combined with MPEG video makes possible highly efficient compression of multimoving information, and recently, various products using the MEPG standards, such as digital televisions (DTV), digital versatile discs (DVD), digital audio broadcasting (DAB), and MP3 players, have been introduced. MP3 audio is denoted by an “.mp3” file extension, indicating it is encoded by the MPEG-1 audio layer 3 method. In addition, MPEG audio uses perceptual coding in which the amount of encoding is reduced by omitting detailed information that is not perceived by humans.

However, the more MP3 audio data is compressed, the more high frequency regions of the MP3 audio data are lost. The tone color of the MP3 audio data changes, clarity of the sounds are lowered, and repressed or dull sounds are produced, due to the loss of the high frequency regions. Therefore, conventional MP3 audio data uses an mp3PRO format of a spectral band replication (SBR) method that improves processed sound quality, to recover lost high frequency components.

FIG. 1 is a block diagram of an mp3PRO decoder performing a conventional SBR method. Referring to FIG. 1, a decoder 110 decodes an mp3PRO bitstream into pulse-code modulation (PCM) audio data and auxiliary data when the mp3PRO bitstream is input to the decoder 110. Here, the PCM audio data is divided into left and right channel audio data, and the auxiliary data includes envelope information. A quadrature mirror filter (QMF) analyzer 120 converts the PCM audio data into low frequency signals with 32 bands. A high frequency generator 130 generates high frequency components according to the envelope information so that the high frequency components are in harmony with components of low frequency regions converted at the QMF analyzer 120. An envelope controller 140 controls the energy of high frequency components according to the envelope information. A QMF mixer 150 mixes the energy of high frequency components controlled at the envelope controller 140 with signals of the low frequency region analyzed at the QMF analyzer 120, and outputs audio data with restored high frequency components. A channel separator 160 outputs audio data with separated left and right channels according to the auxiliary data the decoder 110 generates.

Consequently, the conventional SBR method restores high frequency components of the MP3 audio data via post-processors, that is, the QMF analyzer 120, the high frequency generator 130, the envelope controller 140, and the QMF mixer 150. Therefore, the SBR method has a disadvantage of increasing an amount of calculation by using the post-processors.

In addition, an MP3 encoder (not shown) allocates a different number of bits to each band of the original sound according to the psychoacoustic model. Thus, frequency components that exist when a decoded time domain file is converted into the frequency domain are generated with different accuracies for each band compared to the original sounds. That is, frequency components that were only allocated a few bits include more errors than the original sound. Therefore, the mp3PRO decoding of the SBR method using the post-processors algorithm may include an error in the restored high frequency component since the high frequency components are restored from low frequency components that are allocated different numbers of bits for each band.

### SUMMARY OF THE INVENTION

The present general inventive concept provides a method of and an apparatus to restore high frequency components by assigning significance to frequency components of bands having high accuracy, by using a scale factor for each band of compressed audio within a moving picture experts group audio layer 3 (MP3) decoder.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept are achieved by providing a method of restoring compressed audio, including: setting MDCT (modified discrete cosine transform) coefficients of low bands and high bands of an audio signal based on scale factor information of each band; extracting MDCT coefficients of low bands per band based on scale factors of each band after dequantizing an inputted compressed audio bitstream; selecting the MDCT coefficients of the low bands, which is set in the operation of setting the MDCT coefficients of the low bands and the high bands, that corresponds to patterns of MDCT coefficients of low bands of the inputted compressed audio bitstream, and selecting the MDCT coefficients of the high bands, which is set in the operation of setting the MDCT coefficients of the low bands and the high bands, that matches with the MDCT coefficients of the selected low bands; and performing an inverse MDCT by adding the MDCT coefficients of the high bands selected in the operation of selecting the MDCT coefficients of the high bands with the MDCT coefficients of the low bands in the operation of extracting MDCT coefficients of the low bands.

The foregoing and/or other aspects and advantages of the present general inventive concept may be also achieved by providing an apparatus to store compressed audio, including: a dequatization unit that extracts MDCT coefficients from audio bitstream; a high frequency restoration unit that selects MDCT coefficients of low bands that match with MDCT coefficients for each band based on scale factors, which are set at the dequantization unit, and MDCT coefficients of a vector table already set using scale factor information, and selects MDCT coefficients of high bands that corresponds to the MDCT coefficients of the low bands; and an inverse MDCT unit that inverse MDCTs MDCT coefficients of high bands, which are restored at the high frequency restoration unit, by adding MDCT coefficients of low bands, which are output from the dequantization unit.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a block diagram of an mp3PRO decoder performing a conventional spectral band replication (SBR) method;

FIG. 2 is a block diagram of an apparatus to restore audio data according to an embodiment of the present general inventive concept;

FIG. 3 is a detailed block diagram of a high frequency restoration unit 230 of FIG. 2;

FIG. 4 is a flow chart illustrating a method of restoring audio data according to an embodiment of the present general inventive concept; and

FIG. 5 is a conceptual diagram illustrating the restoration of a high frequency band signal according to the method of FIG. 4.

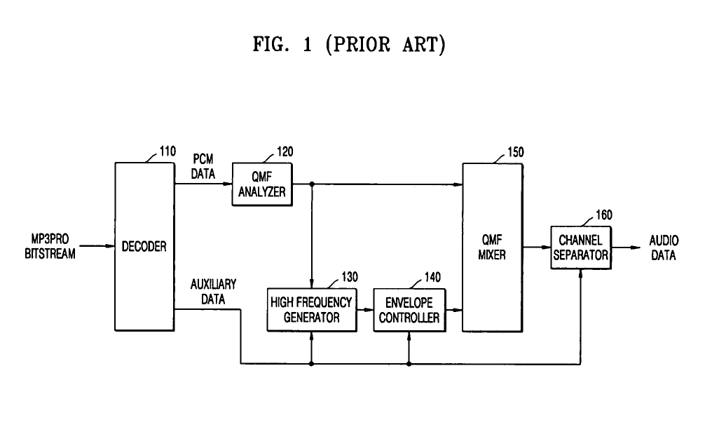

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

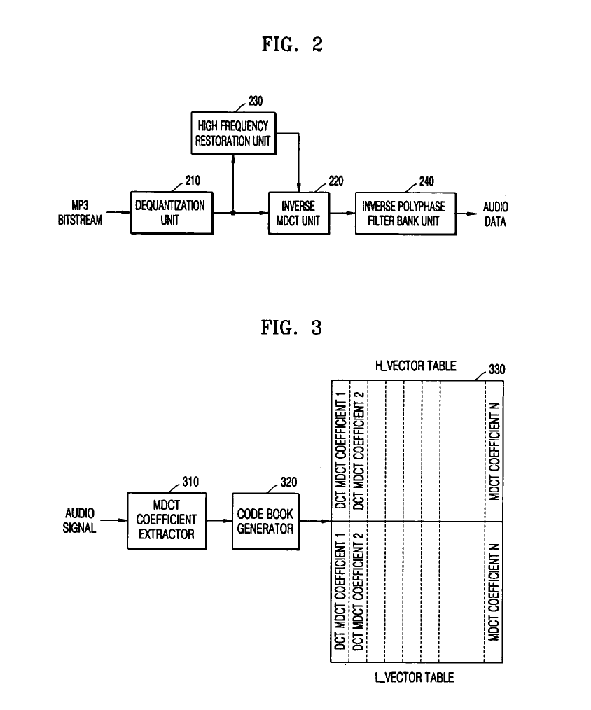

FIG. 2 is a block diagram of an apparatus to restore audio data according to an embodiment of the present general inventive concept. First, the apparatus to restore audio data receives moving picture experts group audio layer 3 (MP3) audio data output from an audio encoder (not shown). Here, the audio encoder compresses audio data in an MP3 format. In the compression process, an audio signal is divided into subbands via 32 filter banks. Then, the subbands are converted into frequency bands having narrower widths than those of the subbands using MDCT. Afterwards, data of each frequency band are quantized using MDCT coefficients and a masking curve of the psychoacoustic model.

Referring to FIG. 2, a dequantization unit 210 extracts MDCT coefficients per band from an MP3 bitstream using a scale factor for each band. Here, dequantized MDCT coefficients are distributed to low frequency bands that lost high frequency bands.

A high frequency restoration unit 230 compares the MDCT coefficients for each band, which are generated by the dequantization unit 210, and MDCT coefficients of a vector table already generated using scaling factor information, and selects a low band MDCT coefficient most similar to the MDCT coefficient for each band, and then selects a high band MDCT coefficient that corresponds to the low band MDCT coefficient. Thus, an MDCT coefficient with restored high frequency is extracted.

An inverse MDCT unit 220 performs inverse MDCT after adding the MDCT coefficients of the high band restored at the high frequency restoration unit 230 and the MDCT coefficients of the low band output from the dequantization unit 210.

An inverse polyphase filter bank unit 240 combines inverse MDCT signals, which are inverted at the inverse MDCT unit 220, by each sub-band, and restores the sub-bands into MP3 audio data by sending the combined sub-bands through a mixing filter (not shown).

FIG. 3 is a detailed block diagram of the high frequency restoration unit 230 of FIG. 2. Referring to FIG. 3, an MDCT coefficient extractor 310 extracts an MDCT coefficient for each band from an audio signal, using scale factor information of each band.

A code book generator 320 generates a code book by vector quantizing MDCT coefficients extracted at the MDCT coefficient extractor 310.

A vector table 330 forms a high band vector table H_VECTOR TABLE and a low band vector table L_VECTOR TABLE by separating the high band MDCT coefficient and the low band MDCT coefficient from the code book, which is generated by the code book generator 320.

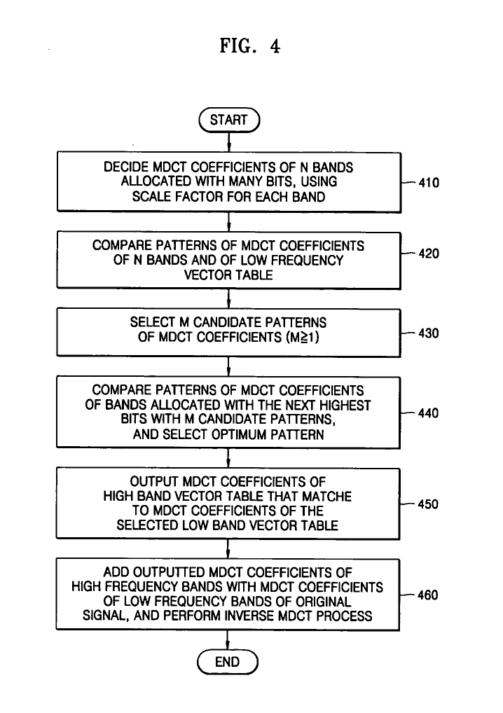

FIG. 4 is a flow chart illustrating a method of restoring audio data according to an embodiment of the present general inventive concept. First, as described in FIG. 3, a vector table of MDCT coefficients for each of the high and low frequency bands of an audio signal are needed.

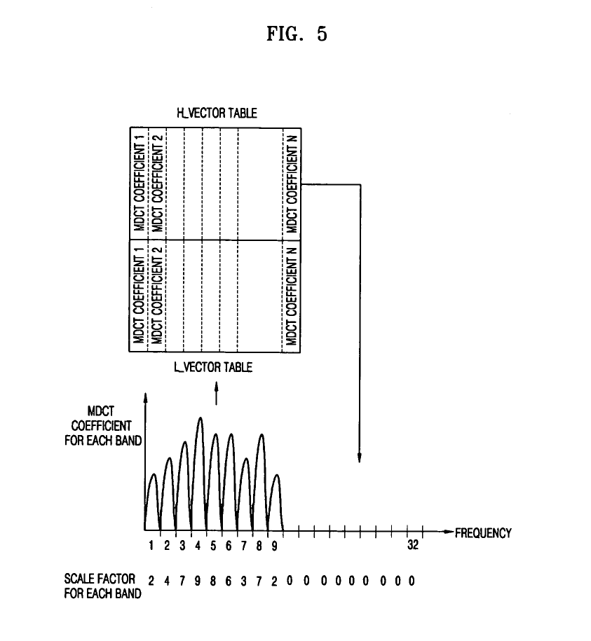

Then, the MP3 audio bit stream that is input to the apparatus to restore audio data is dequantized, and the MDCT coefficients of the low bands per band are extracted based on the scale factor for each band, as illustrated in FIG. 5. Referring to FIG. 5, a scale factor is allocated to 1-9 bands of the low frequency bands, and is not allocated to 10-32 bands, which corresponds to the high frequency bands, because high frequency signals do not exist.

Then, MDCT coefficients of N bands allocated with high number of bits are decided using the scale factor for each band (Operation 410). For example, MDCT coefficients of N bands in the order of having high scale factor, which is bit allocation information, are selected. In other words, assume that MDCT coefficients of fourth and fifth bands in the order of having high scale factor are selected in FIG. 5.

Through comparing patterns of the MDCT coefficients of the fourth and fifth bands and MDCT coefficients of a low band vector table L_VECTOR TABLE, as illustrated in FIG. 5 (Operation 420), patterns of M candidates of MDCT coefficients that have the most similar patterns to each other, that is, having difference of patterns smaller than the threshold value, are selected (Operation 430). Here, M is equal to or bigger than 1.

Besides the fourth and fifth bands that are allocated with many bits, patterns of MDCT coefficients with the next highest allocated bits (e.g., MDCT coefficients of third, sixth, and eight bands) are compared with M candidate patterns, and the optimum pattern is selected (Operation 440).

Then, MDCT coefficient of the high band vector table H_VECTOR TABLE that matches to the MDCT coefficient of the selected low band vector table L_VECTOR TABLE is output (Operation 450).

The MDCT coefficients of the high frequency bands are added with the MDCT coefficients of the low frequency bands, and an inverse MDCT process is performed (Operation 460). Referring to FIG. 5, MDCT coefficients of the high frequency bands (10-32 bands) of the original signal are filled with MDCT coefficients selected from the high band vector table H_VECTOR TABLE.

Consequently, high frequency components are restored by assigning significance to frequency components of bands having high accuracy using the scale factor of each band of compressed audio within an MP3 decoder.

According to the present general inventive concept, additional amount of calculations due to domain conversion can be reduced, and restored sound quality of compressed audio data can be improved by restoring high frequency components lost during MP3 decoding.

The present general inventive concept can be realized as a method, an apparatus, and a system. When the present general inventive concept is manifested in computer software, components of the present general inventive concept may be replaced with code segments that are necessary to perform the required action. Programs or code segments may be stored in media readable by a processor, and transmitted as computer data that is combined with carrier waves via a transmission media or a communication network.

The media readable by a processor include anything that can store and transmit information, such as, electronic circuits, semiconductor memory devices, ROM, flash memory, EEPROM, floppy discs, optical discs, hard discs, optical fiber, radio frequency (RF) networks, etc. The computer data also includes any data that can be transmitted via an electric network channel, optical fiber, air, electromagnetic field, RF network, etc.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A method of restoring compressed audio, comprising:
setting MDCT (modified discrete cosine transform) coefficients of low bands and high bands of an audio signal based on scale factor information of each band;
extracting MDCT coefficients of low bands per band based on scale factors of each band after dequantizing an inputted compressed audio bitstream;
selecting the MDCT coefficients of the low bands, which is set in the operation of setting the MDCT coefficients of the low bands and the high bands, that corresponds to patterns of MDCT coefficients of low bands of the inputted compressed audio bitstream, and selecting the MDCT coefficients of the high bands, which is set in the operation of setting the MDCT coefficients of the low bands and the high bands, that matches with the MDCT coefficients of the selected low bands; and
performing an inverse MDCT by adding the MDCT coefficients of the high bands selected in the operation of selecting the MDCT coefficients of the high bands with the MDCT coefficients of the low bands in the operation of extracting MDCT coefficients of the low bands.

2. The method of claim 1, wherein the operation of setting the MDCT coefficients of the low bands and the high bands comprises:
extracting MDCT coefficients of an audio signal;
generating a code book by vector quantizing the MDCT coefficients extracted in the operation of extracting the MDCT coefficients; and
separating MDCT coefficients of low bands and MDCT coefficients of high bands in the code book generated in the operation of generating the code book, and storing them in a vector table for each band.

3. The method of claim 1, wherein the operation of selecting the MDCT coefficients of the low bands and the high bands comprises:
deciding MDCT coefficient patterns of N bands having scale factors over a predetermined size among the scale factors for each band of the compressed audio data;
selecting M candidate patterns of MDCT coefficients of low bands in which a difference of patterns is smaller than a critical value when the MDCT coefficient patterns of N bands and the pre-set MDCT patterns of the low bands are compared;
deciding MDCT coefficient patterns of N bands of the highest scale factors besides the scale factors in the operation of deciding the MDCT coefficient patterns of N bands, and selecting MDCT coefficients of low bands in which difference of patterns is smaller than a critical value when the MDCT coefficient patterns and the M candidate patterns are compared; and
selecting the MDCT coefficients of the pre-set high bands that matches with the selected MDCT coefficients of the low bands.

4. The method of claim 1, wherein the compressed audio is a moving picture experts group audio layer 3 (MP3) audio data.

5. An apparatus to store compressed audio, comprising:
a dequatization unit that extracts MDCT coefficients from audio bitstream;
a high frequency restoration unit that selects an MDCT coefficient of low bands that matches with MDCT coefficients for each band based on scale factors, which are set at the dequantization unit, and MDCT coefficients of a vector table already set using scale factor information, and selects MDCT coefficients of high bands that corresponds to the MDCT coefficients of the low bands; and
an inverse MDCT unit that inverts MDCTs MDCT coefficients of high bands, which are restored at the high frequency restoration unit, by adding MDCT coefficients of low bands, which are output from the dequantization unit.

6. The apparatus of claim 5, wherein the high frequency restoration unit comprises a vector table that generates a code book by vector quantizing MDCT coefficients of audio signals, and stores MDCT coefficients of low bands and MDCT coefficients of high bands of the code book.

7. A computer readable storage medium containing a method of restoring compressed audio, the method comprising:
setting MDCT (modified discrete cosine transform) coefficients of low bands and high bands of an audio signal, based on scale factor information of each band;
extracting MDCT coefficients of low bands per band based on scale factors of each band after dequantizing an inputted compressed audio bitstream;
selecting the MDCT coefficients of the low bands, which is set in the operation of setting the MDCT coefficients of the low bands and the high bands, that corresponds to patterns of MDCT coefficients of low bands of the inputted compressed audio bitstream, and selecting the MDCT coefficients of the high bands, which is set in the operation of setting the MDCT coefficients of the low bands and the high bands, that matches with the MDCT coefficients of the selected low bands; and
performing an inverse MDCT by adding the MDCT coefficients of the high bands selected in the operation of selecting the MDCT coefficients of the high bands with the MDCT coefficients of the low bands in the operation of extracting MDCT coefficients of the low bands.

8. The computer readable storage medium of claim 7, wherein the operation of setting the MDCT coefficients of the low bands and the high bands comprises:
extracting MDCT coefficients of an audio signal;
generating a code book by vector quantizing the MDCT coefficients extracted in the operation of extracting the MDCT coefficients; and
separating MDCT coefficients of low bands and MDCT coefficients of high bands in the code book generated in the operation of generating the code book, and storing them in a vector table for each band.

9. The computer readable storage medium of claim 7, wherein the operation of selecting the MDCT coefficients of the low bands and the high bands comprises:
deciding MDCT coefficient patterns of N bands having scale factors over a predetermined size among the scale factors for each band of the compressed audio data;
selecting M candidate patterns of MDCT coefficients of low bands in which a difference of patterns is smaller than a critical value when the MDCT coefficient patterns of N bands and the pre-set MDCT patterns of the low bands are compared;
deciding MDCT coefficient patterns of N bands of the highest scale factors besides the scale factors in the operation of deciding the MDCT coefficient patterns of N bands, and selecting MDCT coefficients of low bands in which difference of patterns is smaller than a critical value when the MDCT coefficient patterns and the M candidate patterns are compared; and
selecting the MDCT coefficients of the pre-set high bands that matches with the selected MDCT coefficients of the low bands.

10. The computer readable storage medium of claim 7, wherein the compressed audio is a moving picture experts group audio layer 3 (MP3) audio data.
